(19) United States
(12) Patent Application Publication
(10) Pub. No.: US 2006/0163302 A1
(43) Pub. Date: Jul. 27, 2006

(54) Motorcycle saddlebag mounting system

(75) Inventors: Frederich H. Knoch, Racine, WI (US); Stephen R. Fiacchino, Port Washington, WI (US); Thomas R. Wargin, Menomonee Falls, WI (US); Christopher P. Fredette, West Milwaukee, WI (US)

Correspondence Address: MICHAEL BEST & FRIEDRICH, LLP, 100 E WISCONSIN AVENUE, MILWAUKEE, WI, 53202, US

(73) Assignee: Harley-Davidson Motor Company Group, Inc., Milwaukee, WI (US)

(21) Appl. No.: 11/041,053

(22) Filed: Jan. 21, 2005

(51) Int. Cl. B62J 9/00; B62J 7/00; B62J 11/00

(52) U.S. Cl. 224/413; 224/431

(57) ABSTRACT

A saddlebag mounting system for a motorcycle having a frame. The saddlebag mounting system includes a mounting bracket, a saddlebag bracket, and a saddlebag coupled to the saddlebag bracket. The mounting bracket is coupled to the frame and includes a saddlebag support portion and a first latch component. The saddlebag bracket includes a hook portion and a second latch component. The hook portion is positionable over the saddlebag support portion to support the saddlebag bracket. The saddlebag bracket is pivotable while being supported between a secured position when the first and second latch components are coupled together and an unsecured position when the first and second latch components are uncoupled to each other. At least one of the first and second latch components includes a release mechanism that allows the saddlebag bracket to pivot from the secured position to the unsecured position.

### BACKGROUND

The present invention relates to saddlebags for motorcycles, and more specifically to saddlebag mounting systems for mounting saddlebags to motorcycles.

It is known in the art to use saddlebags to store the belongings of motorcycle riders. It is also known to provide a mounting system for securing the saddlebag to the motorcycle permitting removal of the bag from the motorcycle without the use of tools. Such mounting systems facilitate quick removal of the saddlebag in order to change the appearance of the motorcycle and/or to allow the use of the saddlebag for transporting items away from the motorcycle.

### SUMMARY

The present invention provides a saddlebag mounting system for a motorcycle having a frame. In one embodiment, the saddlebag mounting system includes a mounting bracket, a saddlebag bracket, and a saddlebag coupled to the saddlebag bracket. The mounting bracket is coupled to the frame and includes a saddlebag support portion and a first latch component. The saddlebag bracket includes a hook portion and a second latch component. The hook portion is positionable over the saddlebag support portion to support the saddlebag bracket. The saddlebag bracket is pivotable while being supported between a secured position when the first and second latch components are coupled together and an unsecured position when the first and second latch components are uncoupled to each other. At least one of the first and second latch components includes a release mechanism that allows the saddlebag bracket to pivot from the secured position to the unsecured position.

Other aspects of the invention will become apparent by consideration of the detailed description and accompanying drawings.

### BRIEF DESCRIPTION OF THE DRAWINGS

FIG. 1 is a side view of a motorcycle illustrating a saddlebag mounting system embodying the invention.

FIG. 2 is a partially exploded view of a portion of the saddlebag mounting system shown in FIG. 1.

FIG. 3 is a perspective view of the saddlebag mounting system shown in FIG. 1, illustrating saddlebags of the saddlebag mounting system attached to a mounting bracket of the saddlebag mounting system.

FIG. 4 is a cross-section view taken along line 4-4 in FIG. 3, illustrating a latch of the saddlebag mounting system in the latched position.

FIG. 5 is a cross-section view taken along line 5-5 in FIG. 3.

FIG. 6 is a cross-section view taken along line 6-6 in FIG. 3.

FIG. 7 is a cross-section view similar to FIG. 4, illustrating the latch in the unlatched position.

FIG. 8 is a perspective view similar to FIG. 3, illustrating one of the saddlebags pivoted away from a channel member of the mounting bracket.

FIG. 9 is a cross-section view taken along line 9-9 in FIG. 8.

FIG. 10 is a perspective view similar to FIG. 3, illustrating the saddlebag removed from the mounting bracket.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

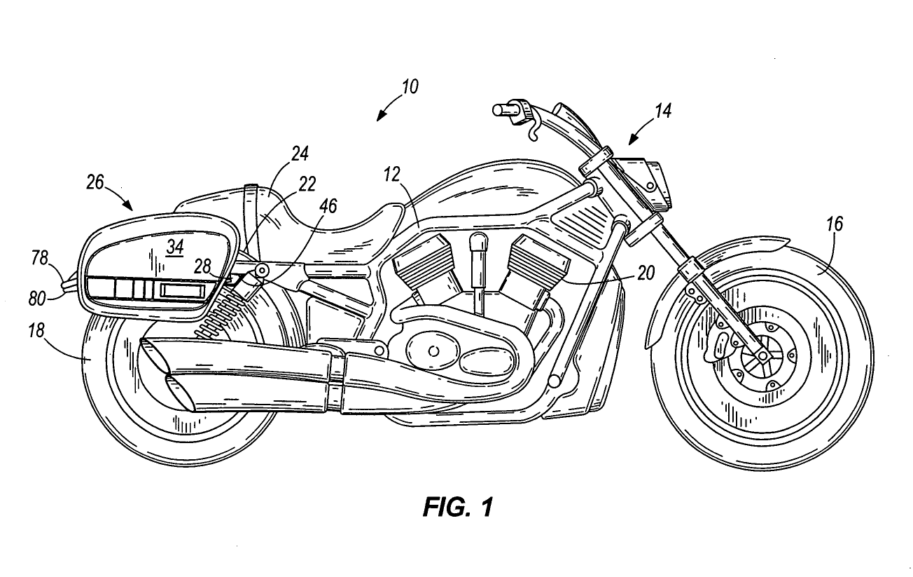

FIG. 1 illustrates a motorcycle 10 including a frame 12, a front steering assembly 14 pivotably mounted to the forward portion of the frame 12, a front wheel 16 rotatably mounted to an end of the steering assembly 14, a rear wheel 18 rotatably mounted to a rearward portion of the frame 12, and an engine/transmission assembly 20 mounted to the frame 12 and operably coupled to the rear wheel 18. The motorcycle 10 includes a rear fender 22 positioned over the rear wheel 18 and coupled to the frame 12 through either rear fender struts (not shown) or by a seat pan (not shown) as is common in the art. A seat 24 is coupled to the frame 12 above the rear wheel 18 and fender 22 to support an operator. The operator controls the engine/transmission assembly 20 to drive the rear wheel 18 and propel the motorcycle 10 and the operator pivots the steering assembly 14 and front wheel 16 to steer the motorcycle 10 while the motorcycle 10 is moving.

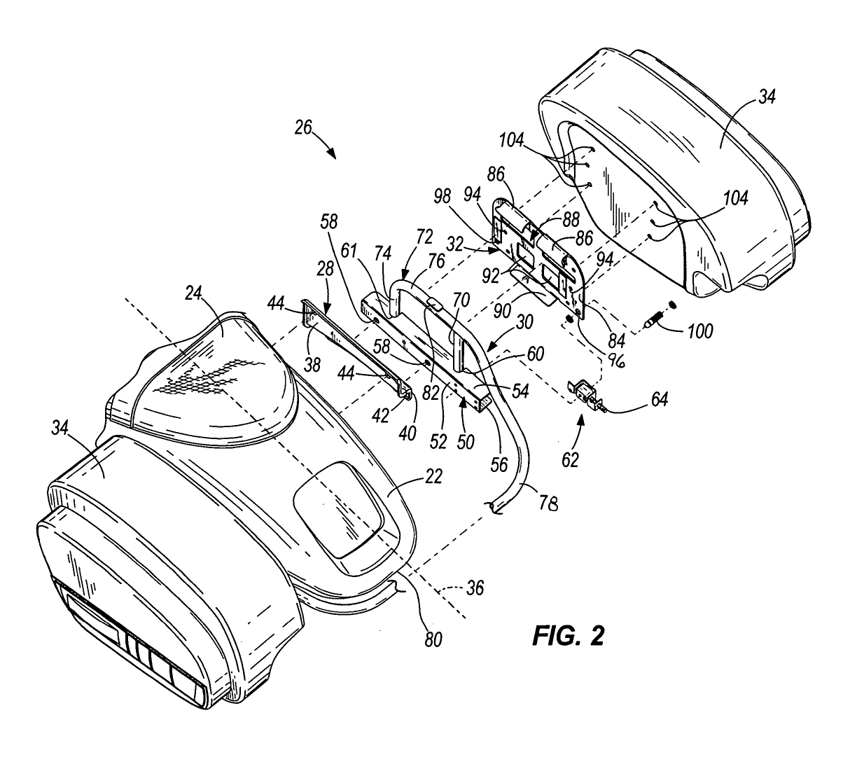

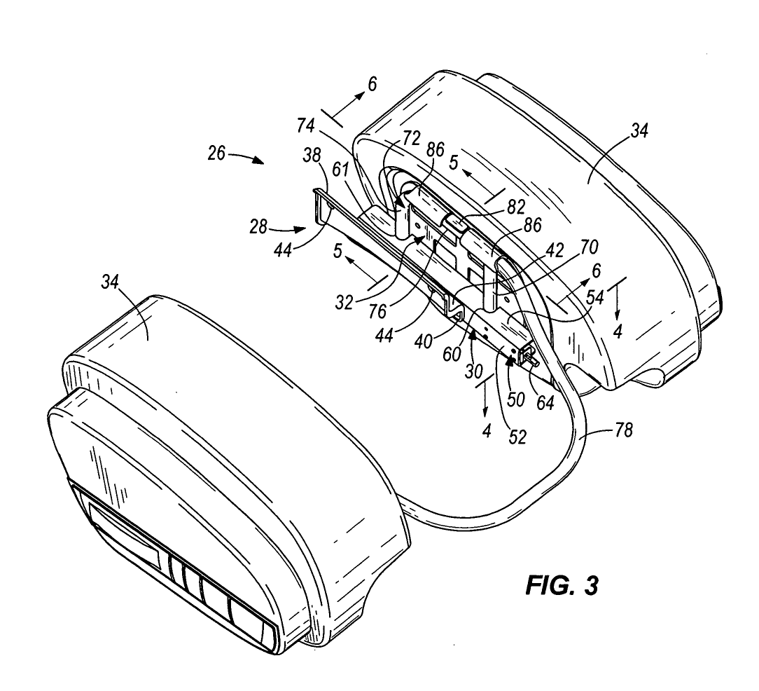

The motorcycle 10 also includes a saddlebag mounting system 26. As shown in FIGS. 2 and 3, the saddlebag mounting system 26 includes fender brackets 28 coupled to the frame 12, a mounting bracket 30 coupled to the fender brackets 28, saddlebag brackets 32 releasably coupled to opposite sides of the mounting bracket 30, and a saddlebag 34 coupled to each respective saddlebag bracket 32. The saddlebag mounting system 26 includes right and left sides that are substantially symmetrical about the longitudinal axis 36 of the motorcycle 10. Only the right side of the saddlebag mounting system 26 will be described in detail below.

The fender bracket 28 includes an upper leg portion 38, a lower leg portion 40, and an intermediate portion 42 connecting the upper and lower leg portions 38, 40. The upper leg portion 38 is vertically oriented and is connected to either a fender strut or a seat pan by passing fasteners through apertures 44. The lower leg portion 40 is also vertically oriented but is offset from the upper leg portion 38 by a distance defined by the thickness of the intermediate portion 42, which is generally normal to the vertical plane. In some embodiments, the upper leg portion 38 is positioned inboard of the fender strut or seat pan and the lower leg portion 40 is positioned outboard of or nearly coplanar with a right side edge 46 of the fender 22 such that apertures 48 on the lower leg portion 40 are exposed. When viewed in cross-section, the intermediate portion 42 is not planar, but rather slopes to match the contour of the right side edge 46 of the fender 22.

The mounting bracket 30 includes an elongated, C-shaped channel member 50 having a center portion 52 and top and bottom portions 54, 56 extending away from outer edges of the center portion 52 in the outboard direction. The center portion 52 includes apertures 58 and fasteners are extended through the apertures 58 and the apertures 48 of the fender bracket 28 to couple the channel member 50 to the fender bracket 28. The top and bottom portions 54, 56 include two pairs of vertically-aligned notches 60, 61 (FIG. 3).

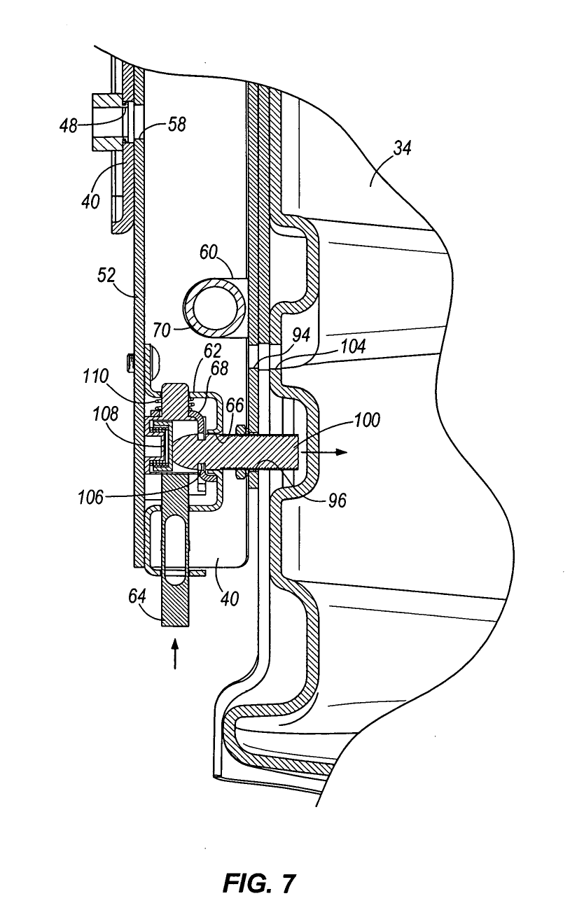

The rearward end of the channel member 50 includes a latch 62 that is positioned within the channel member 50 and connected to the center portion 52 with fasteners. The latch 62 includes a release mechanism 64 extending in a rearward direction from the channel member 50. The latch 62 includes a receiving aperture 66 on the outboard side (FIG. 7). The release mechanism 64 is coupled to a sliding plate 68 within the latch 62 such that the sliding plate 68 partially restricts the aperture 66 of the latch 62 when the release mechanism 64 is extended and does not overlap or interfere with the aperture 66 when the release mechanism 64 is depressed or retracted. One example of an available latch that can be used with the present invention is supplied by SOUTHCO of Concordville, Pa. (P/N: E2-0-34783-24), however other latches can be used.

The mounting bracket 30 also includes a first vertically-oriented tube 70 that can be mounted to the channel member 50 by positioning the tube 70 within the first pair of notches 60 and welding the tube 70 to the top and bottom portions 52, 54. The mounting bracket 30 also includes a second tube 72 having a vertically-oriented forward portion 74, a rearwardly-extending saddlebag support portion 76, and connecting portion 78 that integrally connects to the symmetrical left side of the mounting bracket 30. The forward portion 74 can be mounted to the channel member 50 by positioning the forward portion 74 within the second pair of notches 61 and welding the forward portion 74 to the top and bottom portions 54, 56. The top of the first tube 70 is connected to the saddlebag support portion 76. The connecting portion 78 extends downward from the height of the saddlebag support portion 76 such that the connecting portion 78 is lower than the saddlebag support portion 76. The connecting portion 78 wraps around a rear edge 80 of the fender 22 such that the connecting portion 78 matches the contour of the rear edge 80. The saddlebag support portion 76 includes a raised portion or tab 82 along the length of the saddlebag support portion 76. The second tube 72 of the illustrated embodiment is a single tube that is bent to form the forward portion 74, saddlebag support portion 76, and the connecting portion 78 of both the right and left hand sides. The tab 82 can be a stamped metal piece welded in position to the saddlebag support portion 76.

The saddlebag bracket 32 is a generally planar plate 84 that can be stamped from sheet steel. The saddlebag bracket 32 includes a hook portion on the top side. The hook portion includes first and second hooks 86 that extend inwardly from the plate 84. The first and second hooks 86 are spaced apart from each other to define a gap 88 between the facing edges of the hooks 86. The saddlebag bracket 32 also includes a flange 90 extending inwardly from the bottom edge of the plate 84. The plate 84 includes weight reducing cutouts 92, mounting hole patterns 94, and apertures defining first and second pin mounting locations 96, 98. The saddlebag bracket 32 also includes a pin 100 connected to the first pin mounting location 96. The saddlebag bracket 32 is substantially symmetrical about an axis 102 (FIG. 6) such that a common saddlebag bracket 32 can be used with both the right and left sides of the saddlebag mounting system 26. For example, if the illustrated saddlebag bracket 32 were to be used on the opposite side, the pin 100 would instead be connected to the second pin mounting location 98 thereby positioning the pin 100 in alignment with the latch 62 at the rearward portion of the opposite channel member 50.

The saddlebag 34 is connected to the saddlebag bracket 32 by passing fasteners through apertures 104 that are aligned with the hole patterns 94 of the saddlebag bracket 32. The saddlebag 34 includes a closure mechanism (not shown) that is movable to selectively restrict and provide access to the storage compartment within the saddlebag 34. The storage compartment can be used to store items of the operator during riding or when the motorcycle 10 is at rest.

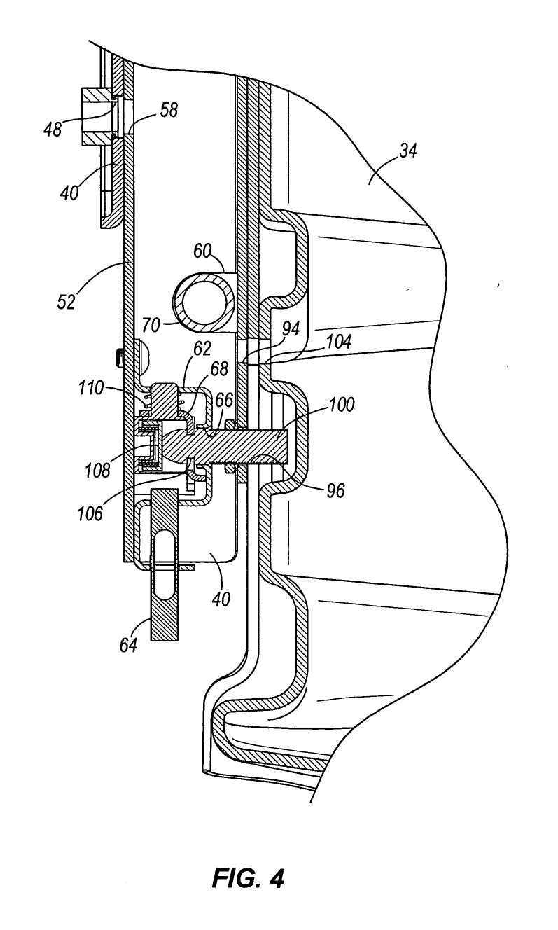

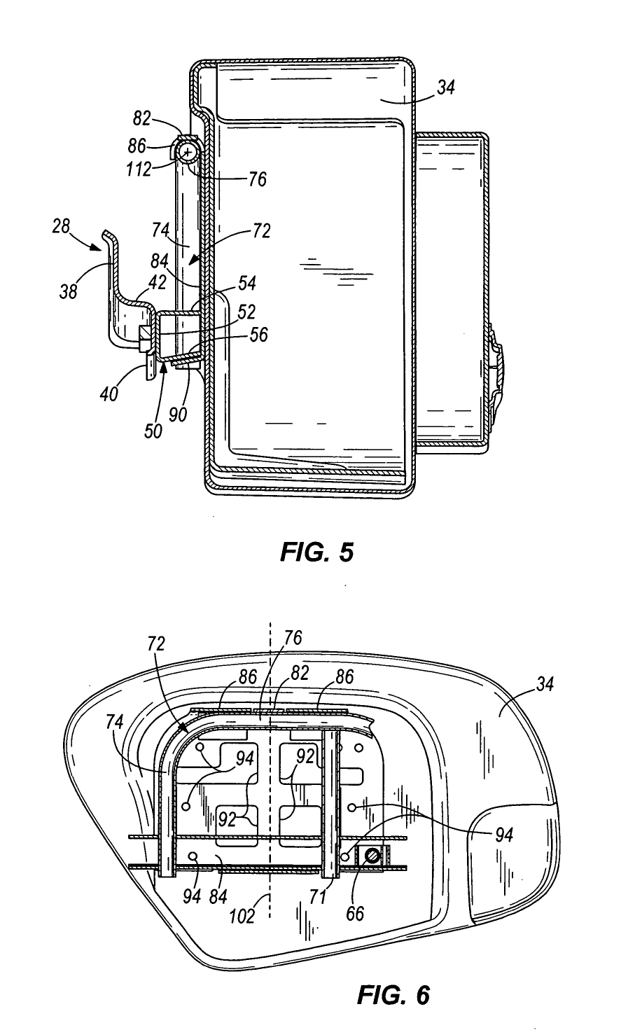

FIGS. 3-10 illustrate the removal of the saddlebag bracket 32 and saddlebag 34 from the mounting bracket 30 and motorcycle 10. With reference to FIG. 3, the saddlebag bracket 32 is shown in the secured position attached to the motorcycle 10. In this position, the hooks 86 engage the saddlebag support portion 76 with the tab 82 positioned within the gap 88 between the hooks 86. As best shown in FIG. 6, the raised tab 82 abuts the facing edges of the hooks 86 to thereby resist movement of the saddlebag bracket 32 in the longitudinal direction. The flange 90 is in contact with the bottom face of the bottom portion 56 of the channel member 50. As best shown in FIG. 5, the flange 90 and bottom portion 56 are slightly angled upward relative to horizontal to prevent the flange 90 from interfering with the bottom portion 56 when the saddlebag bracket 32 pivots about the hooks 86 and the saddlebag support portion 76. The flange 90 resists movement of the saddlebag bracket 32 in the upward direction and in combination with the hooks 86 resist movement in both vertical directions. As shown in FIG. 4, in the secured position the pin 100 is received within the aperture 66 of the latch 62 and slidable plate 68 such that a notch 106 in the pin 100 receives a portion of the slidable plate 68. The plate 84 within the notch 106 resists the removal of the pin 100 from the latch 62 thereby defining a latched condition. In the illustrated embodiment, the pin 100 is connected to the saddlebag bracket 32 and the latch 62 is connected to the channel member 50. However, in other embodiments the mounting locations of these latch components 62, 100 can be reversed such that the latch 62 is mounted to the saddlebag bracket 32 and the pin 100 is mounted to the channel member 50 or elsewhere on the mounting bracket 30.

To begin removal of the saddlebag 34 and saddlebag bracket 32 from the motorcycle 10, the operator reaches from the rear of the motorcycle 10 to depress the release mechanism 64. As best shown in FIG. 7, when the release mechanism 64 is pressed, the sliding plate 68 moves from the notch 106 of the pin 100 thereby allowing the pin 100 to be removed from the aperture 66 of the latch 62. The latch 62 includes a biasing mechanism 108 that pushes the pin 100 in an outward direction when the release mechanism 64 is pressed. The release mechanism 64 is biased by a spring 110 into the extended position and the sliding plate 68 is biased by the spring 110 into the engaged position overlapping the latch aperture 66.

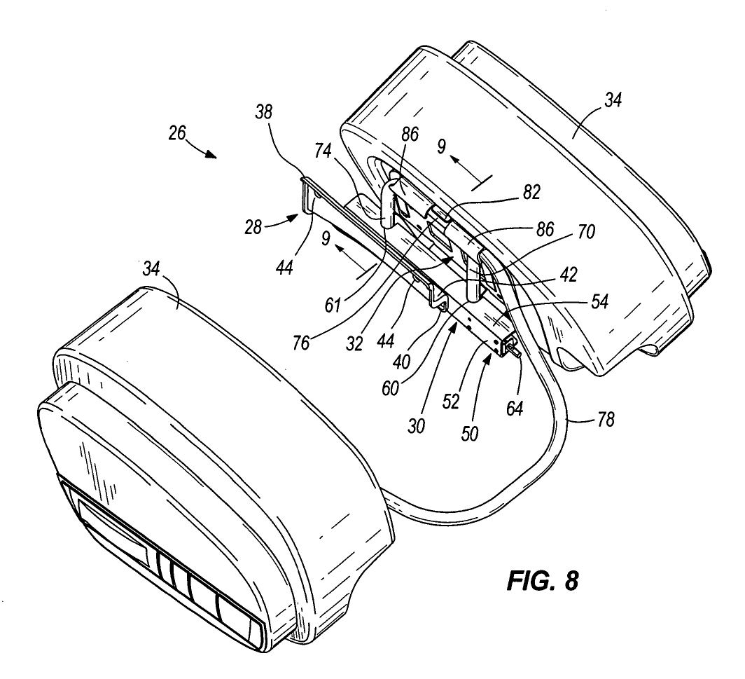

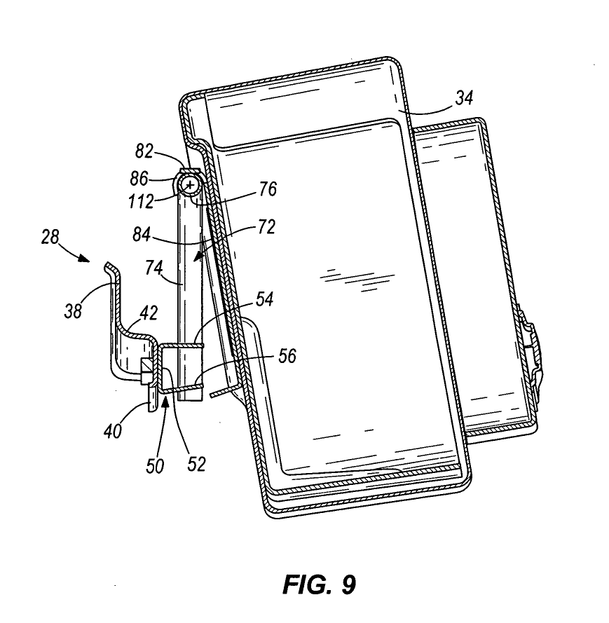

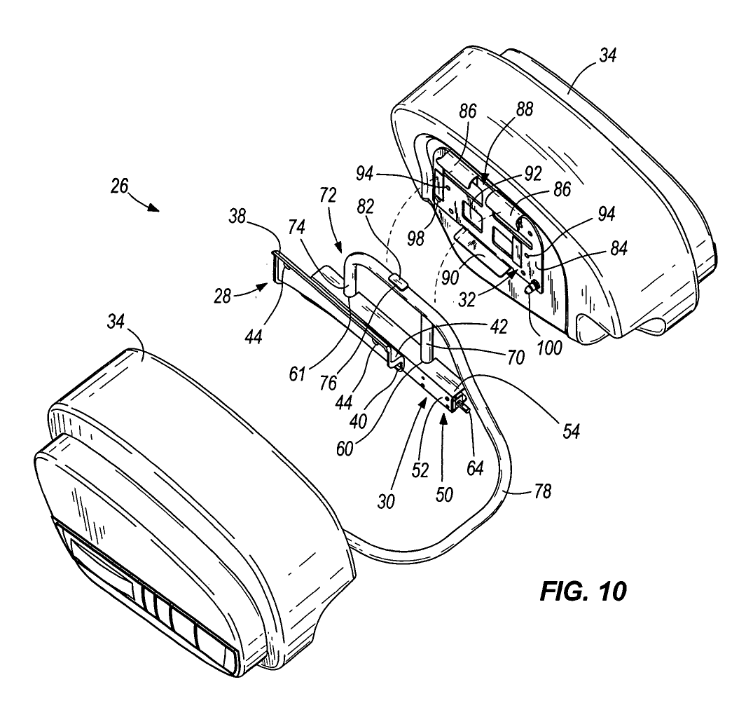

As illustrated in FIGS. 8 and 9, once the pin 100 is released from the latch 62 the lower portion of the saddlebag bracket 32 and saddlebag 34 can be pivoted away from the channel member 50 about an axis 112 defined by the hooks 86 and the saddlebag support portion 76. In this pivoted position, the saddlebag bracket 32 and saddlebag 34 remain supported by the hooks 86 engaged with the saddlebag support portion 76. As shown in FIG. 10, the saddlebag bracket 32 and saddlebag 34 are then lifted to remove the hooks 86 from the saddlebag support portion 76. After the saddlebag 34 is removed from the motorcycle 10 into the unsecured position, the mounting bracket 30 can remain on the motorcycle 10.

The procedure for removing the saddlebag 34 is basically reversed to attach the saddlebag 34 to the motorcycle 10. First, the hooks 86 are positioned over the saddlebag support portion 76 such that the tab 82 is positioned between the hooks 86 and the saddlebag bracket 32 is pivoted away from the channel member 50. The tab 82 and hooks 86 also help to align the pin 100 with the latch 62. The saddlebag 34 is then pivoted toward the channel member 50 so that the pin 100 enters into the latch 62 and the flange 90 contacts the bottom face of the bottom portion 56. The rounded end of the pin 100 moves the sliding plate 68 out of an interference position with the pin 100 as the pin 100 enters the latch 62. The spring 110 then moves the sliding plate 68 into the notch 106 when the notch 106 is moved within the plane of the sliding plate 68. The latch components are then in the latched position and the saddlebag 34 is secured to the mounting bracket 30.

Various features and advantages of the invention are set forth in the following claims.

What is claimed is:

1. A saddlebag mounting system for a motorcycle having a frame, the saddlebag mounting system comprising:
a mounting bracket coupled to the frame, the mounting bracket having a saddlebag support portion and a first latch component;
a saddlebag bracket including a hook portion and a second latch component, wherein the hook portion is positionable over the saddlebag support portion to support the saddlebag bracket, wherein the saddlebag bracket is pivotable while being supported between a secured position when the first and second latch components are coupled together and an unsecured position when the first and second latch components are uncoupled to each other, wherein at least one of the first and second latch components includes a release mechanism that allows the saddlebag bracket to pivot from the secured position to the unsecured position; and
a saddlebag coupled to the saddlebag bracket.

2. The saddlebag mounting system of claim 1, wherein the saddlebag bracket includes a flange that contacts the mounting bracket in the secured position such that the hook portion and flange resist vertical motion of the saddlebag bracket relative to the mounting bracket.

3. The saddlebag mounting system of claim 1, wherein the hook portion includes two hooks spaced apart a distance in a first direction to form a gap, and wherein the saddlebag support portion includes a raised portion adapted to be received in the gap such that the two hooks and the raised portion resist movement of the saddlebag bracket relative to the mounting bracket in the first direction.

4. The saddlebag mounting system of claim 1, wherein the mounting bracket includes an additional saddlebag support structure and wherein the saddlebag mounting system further comprises an additional saddlebag bracket and an additional saddlebag coupled to the additional saddlebag.

5. The saddlebag mounting system of claim 4, wherein the saddlebag support portion and the additional saddlebag support portion are connected together by a connecting portion.

6. The saddlebag mounting system of claim 5, wherein the saddlebag support portion, the additional saddlebag support portion, and the connecting portion are tubular and integrally formed.

7. The saddlebag mounting system of claim 5, wherein the motorcycle includes a fender coupled to the frame, the fender having a rear edge, wherein the connecting portion wraps around the fender and follows the contour of the rear edge.

8. The saddlebag mounting system of claim 5, wherein the saddlebag support portion and the additional saddlebag support portion are positioned at a height that is different from the height of the connecting portion.

9. The saddlebag mounting system of claim 1, wherein the release mechanism projects rearwardly from the mounting bracket.

10. The saddlebag mounting system of claim 1, wherein the saddlebag bracket includes first and second sides that are substantially symmetrical about an axis.

11. The saddlebag mounting system of claim 10, the first latch component includes a latch and the second latch component includes a pin, and wherein the saddlebag bracket includes a first pin mounting location on the first side and a second pin mounting location on the second side, and wherein the pin is coupled to one of the first and second mounting locations.

12. A saddlebag for a motorcycle, the motorcycle including a frame and a mounting bracket coupled to the frame, the mounting bracket having a saddlebag support portion and a first latch component, the saddlebag comprising:
a saddlebag bracket including a hook portion and a second latch component, wherein the hook portion is adapted to be positioned over the saddlebag support portion to support the saddlebag bracket, wherein the saddlebag bracket is adapted to be pivoted while being supported between a secured position when the first and second latch components are coupled together and an unsecured position when the first and second latch components are uncoupled to each other, wherein at least one of the first and second latch components includes a release mechanism that allows the saddlebag bracket to pivot from the secured position to the unsecured position.

13. The saddlebag of claim 12, wherein the saddlebag bracket includes a flange adapted to be positioned underneath the mounting bracket in the secured position such that the hook portion and flange resist vertical motion of the saddlebag bracket relative to the mounting bracket.

14. The saddlebag of claim 12, wherein the hook portion includes two hooks spaced apart a distance in a first direction to form a gap, and wherein the saddlebag support portion includes a raised portion, and wherein the gap is adapted receive the raised portion such that the two hooks and the raised portion resist movement of the saddlebag bracket relative to the mounting bracket in the first direction.

15. The saddlebag of claim 12, wherein the saddlebag bracket includes first and second sides that are substantially symmetrical about an axis.

16. The saddlebag of claim 15, the first latch component includes a latch and the second latch component includes a pin, and wherein the saddlebag bracket includes a first pin mounting location on the first side and a second pin mounting location on the second side, and wherein the pin is coupled to one of the first and second mounting locations.

17. The saddlebag of claim 15, wherein the saddlebag bracket includes a hole pattern on the first side and a hole pattern on the second side, the saddlebag mounted to the saddlebag bracket by fasteners extending through holes of the hole patterns, wherein the hole patterns are substantially symmetrical about the axis.
